(19) United States
(12) Patent Application Publication
(10) Pub. No.: US 2020/0262242 A1
(43) Pub. Date: Aug. 20, 2020

(54) FIBER BELT INCLUDING FERROUS ELEMENT FOR MAGNETIC MANIPULATION

(71) Applicant: Bridgestone Americas Tire Operations, LLC, Nashville, TN (US)

(72) Inventors: David J. Zemla, Canal Fulton, OH (US); Jon I. Stuckey, Uniontown, OH (US)

(21) Appl. No.: 15/774,529

(22) PCT Filed: Oct. 21, 2016
(86) PCT No.: PCT/US16/58020

§ 371 Date: May 8, 2018

Related U.S. Application Data
(60) Provisional application No. 62/257,251, filed on Nov. 19, 2015.

(51) Int. Cl. B60C 9/00; B29D 30/00

(52) U.S. Cl. CPC B60C 9/005; B60C 9/0007; B29D 2030/0038; B29D 30/0016; B60C 9/0042

(57) ABSTRACT

A fiber belt including at least one ferrous element is provided. The inclusion of the ferrous element, for example a ferrous cord, may permit magnetic manipulation of the belt. In one embodiment, a tire belt is provided, the belt comprising: a plurality of non-magnetic cords oriented in a row substantially parallel to one another; at least one ferrous cord oriented in a row substantially parallel to the plurality of non-magnetic cords; and wherein the plurality of non-magnetic cords and the at least one ferrous cord are calendered in a rubber material.

### BACKGROUND

Many vehicle tires, and especially pneumatic tires, include at least one belt ply. A belt is a circumferential reinforcement ply in a tire. A belt, or belt ply, typically includes cords calendered in a rubber material. Traditional belt cord material is steel, but alternative materials such as fiberglass or aramid (or other fibers or polymers) may be used as a replacement for steel.

In building a tire, a roll of belt ply material may be housed on a drum and applied to a tire after the tire carcass is expanded on the building drum. In practice, the belt ply material may be measured and cut so as to ensure that it extends about the expanded tire carcass exactly one time, with little or no gap or overlap between its circumferential ends. Optionally, one or more additional layers of belt ply material may be applied to the expanded tire carcass. Where the belt cord material is a steel, or another ferrous material that attracts a magnet, a magnetic assist system may be utilized to feed the belt ply through a cutter and drum server. The magnetic assist system may be used to apply the section of belt ply material to the tire carcass. The magnetic assist system may selectively capture and release the belt ply material through magnetic attraction between the magnetic assist system and the magnet-attracting ferrous belt cord material.

As non-magnetic belt cord materials, such as a fiberglass, aramid, or other fibers or polymers, are negligibly, or not, attracted to a magnet, non-magnetic fiber belts may not be manipulated with a magnetic assist system.

What is needed is a non-magnetic, fiber belt including an additional magnet-attracting ferrous cord material to permit magnetic manipulation of the belt ply. What is also needed is a system for manipulation of a belt ply having a mixture of ferrous and non-magnetic cord materials.

### SUMMARY

In one embodiment, a tire belt is provided, the belt comprising: a plurality of non-magnetic cords oriented in a row substantially parallel to one another; at least one ferrous cord oriented in a row substantially parallel to the plurality of non-magnetic cords; and wherein the plurality of non-magnetic cords and the at least one ferrous cord are calendered in a rubber material.

In one embodiment, a tire belt magnetic assist system is provided, the system comprising: a tire belt including: a plurality of non-magnetic cords oriented in a row substantially parallel to one another; at least one ferrous cord oriented in a row substantially parallel to the plurality of non-magnetic cords; wherein the plurality of non-magnetic cords and the at least one ferrous cord are calendered in a rubber material; and a magnetic assist system including at least one magnetic handling device.

In one embodiment, a tire is provided, the tire comprising: a tire belt including: a plurality of non-magnetic cords oriented in a row substantially parallel to one another; at least one ferrous cord oriented in a row substantially parallel to the plurality of non-magnetic cords; and wherein the plurality of non-magnetic cords and the at least one ferrous cord are calendered in a rubber material.

### BRIEF DESCRIPTION OF THE DRAWINGS

The accompanying figures, which are incorporated in and constitute a part of the specification, illustrate various example systems and apparatuses, and are used merely to illustrate various example embodiments. In the figures, like elements bear like reference numerals.

FIG. 1 illustrates a sectional view of a tire 100 having a belt 110.

FIG. 2 illustrates a sectional view of a fiber belt 210 including a non-magnetic cord 214 and a ferrous cord 216.

FIG. 3 illustrates a sectional view of a fiber belt 310 including a non-magnetic cord 314 and a ferrous cord 316.

FIG. 4 illustrates a sectional view of a fiber belt 410 including a non-magnetic cord 414 and a ferrous cord 416.

FIG. 5 illustrates a sectional view of a fiber belt 510 including a non-magnetic cord 514 and a ferrous cord 516.

FIG. 6 illustrates a sectional view of a fiber belt 610 including a non-magnetic cord 614 and a ferrous cord 616.

FIG. 7 illustrates a sectional view of a fiber belt 710 including a non-magnetic cord 714 and a ferrous cord 716.

FIG. 8 illustrates a sectional view of a fiber belt 810 including a non-magnetic cord 814 and a ferrous cord 816.

FIG. 9 illustrates a sectional view of a fiber belt 910 including a non-magnetic cord 914 and a ferrous cord 916.

FIG. 10A illustrates a sectional view of a fiber belt 1010 including a non-magnetic cord 1014 and a ferrous cord 1016.

FIG. 10B illustrates a sectional view of fiber belt 1010 including non-magnetic cord 1014 and ferrous cord 1016.

FIG. 11 illustrates a sectional view of a fiber belt 1110 including a non-magnetic cord 1114 and a ferrous cord 1116, interacting with magnetic handling devices 1122.

FIG. 12 illustrates a sectional view of a prior art belt 1210.

### DETAILED DESCRIPTION

In the manufacture of a vehicle tire, the tire is typically assembled in a tire plant on a tire building drum. The building drum may accept various components of the tire so that the components may be assembled in order, and positioned relative to one another to form a “green” or uncured tire.

One step in the building of the tire may be the expansion and/or turnup of the tire carcass, wherein the tire components are expanded from a generally cylindrical shape into a generally annular shape. Following this step, the one or more belt ply of the tire may be applied to the tire. The belt ply material may be contained in a roll that includes enough material to prepare one or more tire.

The belt ply may include cords, which may be oriented on an angle (bias) relative to the centerline of the tire. A plurality of belt plies may be applied to a tire, wherein the cord angles of one belt ply are opposed to the cord angles of another belt ply.

Belt plies are circumferentially placed reinforcement plies in the tire crown region, and may also be commonly referred to as “belts,” “stabilizer plies,” etc. Belt plies are typically constructed from rubber-coated cords that are sheeted out and cut on a bias angle and additionally cut to a belt ply width. Pairs of belt plies are typically placed with opposing bias angles circumferentially around a tire carcass after the carcass has been expanded on a tire building drum. By design, belt plies stretch very little in a radial direction, thus providing circumferential reinforcement within a tire.

The loose end of the belt ply material extending from the roll may be engaged by a drum server, which may act to position and apply the belt ply to the expanded green tire carcass. The belt ply may be pushed toward and into the drum server via a system, including for example a magnetic assist system. The belt ply may be fed through the server until the proper length is achieved (e.g., the length necessary for the belt ply to extend completely around the tire with little or no gap or overlap between the ends of the belt), at which point the belt ply may be severed from the remainder of the belt ply material contained in the roll.

Where the belt ply contains only steel cords, and the steel cords are attracted to a magnet, a magnetic assist system may include magnetized feeder belts to push the belt ply into the server.

Where the belt ply contains only non-magnetic non-magnetic cords, and the non-magnetic cords are not attracted to a magnet or are negligibly attracted to a magnet, a magnetic assist system is not able to push the belt ply into the server. In such a situation, a person operating the drum must manually hand feed the belts into the server for cutting, on each tire. This manual feeding is very time consuming and it may be difficult to maintain consistency between one belt ply and another belt ply.

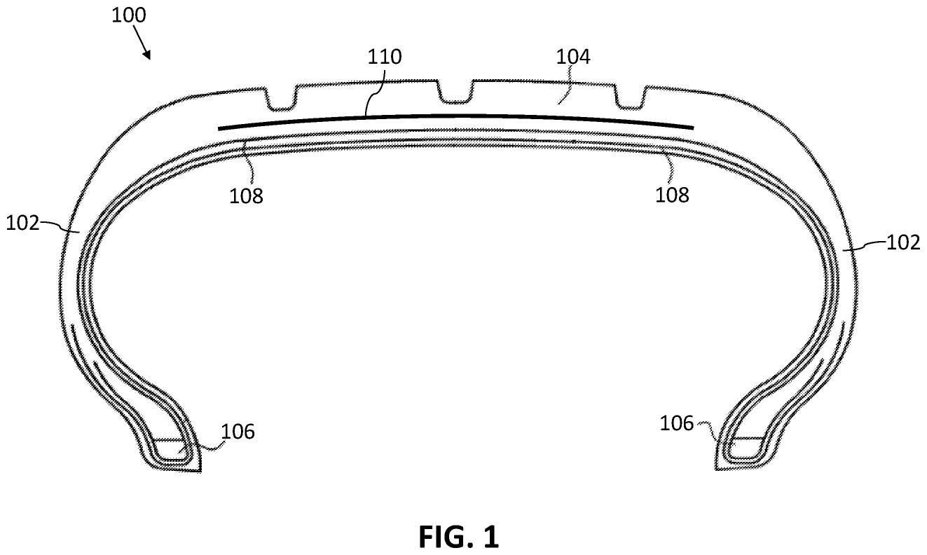

FIG. 1 illustrates a sectional view of a tire 100 having at least one belt 110. Tire 100 may include at least one sidewall 102. Tire 100 may include a tread portion 104. Tire 100 may include at least one bead portion 106. Tire 100 may include at least one carcass ply 108.

Tire 100 may include two sidewalls 102 and two bead portions 106. Each sidewall 102 may be oriented between bead portion 106 and tread portion 104.

Tread portion 104 may be oriented between two sidewalls 102. Tread portion 104 may include the crown portion of the tire. Tread portion 104 may include tread gauge oriented radially outwardly of belt 110. At least one belt 110 may be oriented radially inwardly of at least a portion of, or all of, tread portion 104. At least one belt 110 may be oriented axially within the axially outer portions of tread portion 104. At least one belt 110 may be oriented such that it extends axially outside of the axially outer portions of tread portion 104. At least one belt 110 may have a first belt edge extending axially outside of the axially outer portion of tread portion 104, and a second belt edge terminating axially inside of the axially outer portion of tread portion 104.

Belt 110 may be oriented radially outside of at least one carcass ply 108. Belt 110 may be oriented radially inside of at least one carcass ply 108.

Belt 110 may include a circumferential reinforcement ply in a tire. Belt 110 may include one or more belt ply, or layer. Belt 110 may include cords calendered in a rubber material. Belt 110 may include cords calendered in any of a variety of materials, including for example a polymer, a rubber, or the like. Belt 110 may include cords inclined at an angle relative to the circumferential direction of the tire. Belt 110 may include cords parallel to the circumferential direction of the tire.

Belt 110 may include cords having any of a variety of materials, including a non-magnetic fiber material, a ferrous steel material, a metal, a polymer, a composite, an organic material, and the like. Belt 110 may include non-magnetic cords made from a fiber material. Belt 110 may include non-magnetic cords made from a fiberglass material. Belt 110 may include non-magnetic cords made from an aramid material. Belt 110 may include a plurality of cords made from a non-magnetic fiber material, such as a fiberglass material or an aramid material, and at least one cord made from a magnet-attracting ferrous material, such as a steel. The term “ferrous” as it is used herein is intended to represent a material that is attracted to a magnetic field in a significant manner.

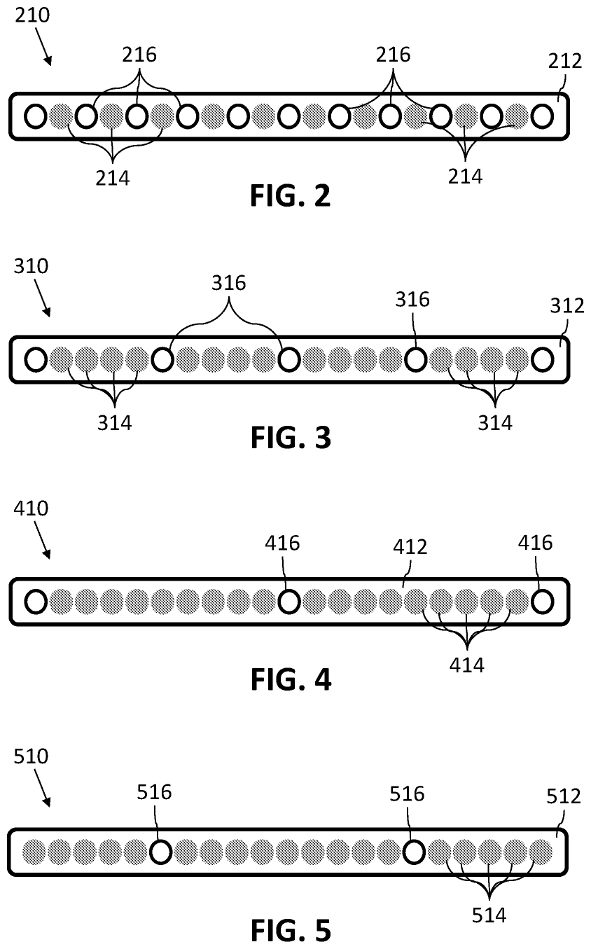

FIG. 2 illustrates a sectional view of a fiber belt 210 including a non-magnetic cord 214 and a magnet-attracting ferrous cord 216.

Belt 210 may include cords 214, 216 calendered in a material. The material may include a rubber material 212. Rubber material 212 may at least partially encapsulate cords 214, 216. Rubber material 212 may completely encapsulate cords 214, 216.

Non-magnetic cord 214 may include continuous strands of cord material. Non-magnetic cord 214 may include discontinuous strands of cord material, which may include ends at each edge of belt 210.

Non-magnetic cord 214 may include any of a variety of fiber materials. Non-magnetic cord 214 may include a fiber material, including for example, a fiberglass material, an aramid material, and the like. Non-magnetic cord 214 may include any non-magnetic material. Non-magnetic cord 214 may include a polymer, organic fiber, composite material, alloy material, and the like.

Non-magnetic cord 214 may include a solid strand of material. Non-magnetic cord 214 may include a plurality of smaller strands of material joined together in any of a variety of manners, including for example, via braiding, weaving, and the like.

Non-magnetic cord 214 may include any of a variety of cross-sectional shapes, including for example, a circle, an oval, a square, a rectangle, a triangle, a pentagon, a hexagon, an octagon, and the like. Non-magnetic cord 214 may include any of a variety of cross-sectional shapes, including for example any regular shape or any irregular shape.

Non-magnetic cord 214 may include a diameter, or width, depending upon cross-sectional shape. Non-magnetic cord 214 may include a tensile strength measured longitudinally about non-magnetic cord 214.

Ferrous cord 216 may include continuous strands of cord material. Ferrous cord 216 may include discontinuous strands of cord material, which may include ends at each edge of belt 210. Ferrous cord 216 may include discontinuous strands of cord material, which may include ends extending to, or terminating within, one or more edge of belt 210. That is, ferrous cord 216 may be much shorter in length than non-magnetic cord 214. Ferrous cord 216 may extend only partially from one edge of belt 210 to another edge of belt 210.

Ferrous cord 216 may include any of a variety of materials. Ferrous cord 216 may include a ferrous material, including for example, a steel. Ferrous cord 216 may include any ferrous material. Ferrous cord 216 may include a composite material. Ferrous cord 216 may be a steel wire.

Ferrous cord 216 may include a solid strand of material. Ferrous cord 216 may include a plurality of smaller strands of material joined together in any of a variety of manners, including for example, via braiding, weaving, and the like.

Ferrous cord 216 may include any of a variety of cross-sectional shapes, including for example, a circle, an oval, a square, a rectangle, a triangle, a pentagon, a hexagon, an octagon, and the like. Ferrous cord 216 may include any of a variety of cross-sectional shapes, including for example any regular shape or any irregular shape.

Ferrous cord 216 may include a diameter, or width, depending upon cross-sectional shape. Ferrous cord 216 may include a tensile strength measured longitudinally about ferrous cord 216.

Ferrous cord 216 may have a diameter, or width, less than the diameter, or width, of non-magnetic cord 214. Ferrous cord 216 may have a diameter, or width, greater than the diameter, or width, of non-magnetic cord 214. Ferrous cord 216 may have a diameter, or width, about equal to the diameter, or width, of non-magnetic cord 214. Ferrous cord 216 may have a diameter, or width, equal to the diameter, or width, of non-magnetic cord 214.

Ferrous cord 216 may have a tensile strength less than the tensile strength of non-magnetic cord 214. Ferrous cord 216 may have a tensile strength greater than the tensile strength of non-magnetic cord 214. Ferrous cord 216 may have a tensile strength about equal to the tensile strength of non-magnetic cord 214.

The sum of non-magnetic cords 214 may include a tensile strength capable of providing all necessary circumferential reinforcement within a tire. In one embodiment, the sum of non-magnetic cords 214 includes a tensile strength capable of providing all necessary circumferential reinforcement within a tire. That is, non-magnetic cords 214, taken as a whole, may provide all tensile strength necessary for circumferential reinforcement within a tire as a belt ply.

The sum of ferrous cords 216 may include a tensile strength incapable of providing any necessary circumferential reinforcement within a tire. In one embodiment, the sum of ferrous cords 216 does not include a tensile strength capable of providing any necessary circumferential reinforcement within a tire. That is, ferrous cords 216, taken as a whole, may not provide enough tensile strength to be used alone as circumferential reinforcement within a tire as a belt ply. In another embodiment, ferrous cords 216, taken as a whole, do not provide any tensile strength to be used as circumferential reinforcement within a tire.

Belt 210 may include a width measured in the axial direction of the tire. Belt 210 may include a thickness measured in the radial direction of the tire.

Non-magnetic cord 214 and ferrous cord 216 may be substantially equally distributed throughout the width and/thickness of belt 210. In one embodiment, about 50 percent of cords 214, 216 are non-magnetic cords 214 and about 50 percent of cords 214, 216 are ferrous cords 216. In another embodiment, less than 50 percent of cords 214, 216 are ferrous cords 216. Ferrous cords 216 may make up less than or equal to 25 percent of cords 214, 216. Ferrous cords 216 may make up less than or equal to 25 percent of cords 214, 216. Ferrous cords 216 may make up about 5 percent, 10 percent, 15 percent, 20 percent, 25 percent, 30 percent, 35 percent, 40 percent, 45 percent, or 50 percent of the total number of cords 214, 216.

Non-magnetic cord 214 and ferrous cord 216 may be substantially equally distributed across the width of belt 210. That is, ferrous cords 216 may be substantially evenly distributed between non-magnetic cords 214 across the width of belt 210. That is, ferrous cords 216 may be evenly distributed between non-magnetic cords 214 across the width of belt 210. In another embodiment, non-magnetic cords 214 and ferrous cords 216 are not equally distributed across the width of the belt, and certain areas across the width of the belt may have a higher or lower density of ferrous cords 216 than other areas.

Cords 214, 216 may be substantially parallel to one another. Cords 214, 216 may be parallel to one another. Cords 214, 216 may be oriented in a single row extending axially. Cords 214, 216 may be oriented in a single row, such that each of cords 214, 216 is about the same radial distance from the center of the tire.

In another embodiment, cords 214, 216 may be oriented in a plurality of rows, such that each of cords 214, 216 is not about the same radial distance from the center of the tire. For example, cords 214, 216 may be “picketed” such that axially adjacent cords are in separate rows. In one embodiment, ferrous cords 216 may be in a different row than non-magnetic cords 214.

FIG. 3 illustrates a sectional view of a fiber belt 310 including a non-magnetic cord 314 and a ferrous cord 316. Belt 310 may include cords 314, 316 calendered in a material. The material may include a rubber material 312. It is understood that each of the elements of FIG. 3 may have the same properties as described above with respect to those elements of FIG. 2.

As illustrated, the ratio of ferrous cords 316 to total cords 314, 316 may be about 1:4. Ferrous cords 316 may be substantially evenly distributed amongst non-magnetic cords 314 across the width of belt 310.

FIG. 4 illustrates a sectional view of a fiber belt 410 including a non-magnetic cord 414 and a ferrous cord 416. Belt 410 may include cords 414, 416 calendered in a material. The material may include a rubber material 412. It is understood that each of the elements of FIG. 4 may have the same properties as described above with respect to those elements of FIG. 2.

As illustrated, the ratio of ferrous cords 416 to total cords 414, 416 may be about 1:7. Ferrous cords 416 may be substantially evenly distributed amongst non-magnetic cords 414 across the width of belt 410.

FIG. 5 illustrates a sectional view of a fiber belt 510 including a non-magnetic cord 514 and a ferrous cord 516. Belt 510 may include cords 514, 516 calendered in a material. The material may include a rubber material 512. It is understood that each of the elements of FIG. 5 may have the same properties as described above with respect to those elements of FIG. 2.

As illustrated, the ratio of ferrous cords 516 to total cords 514, 516 may be about 1:10. Ferrous cords 516 may be substantially evenly distributed amongst non-magnetic cords 514 across the width of belt 510.

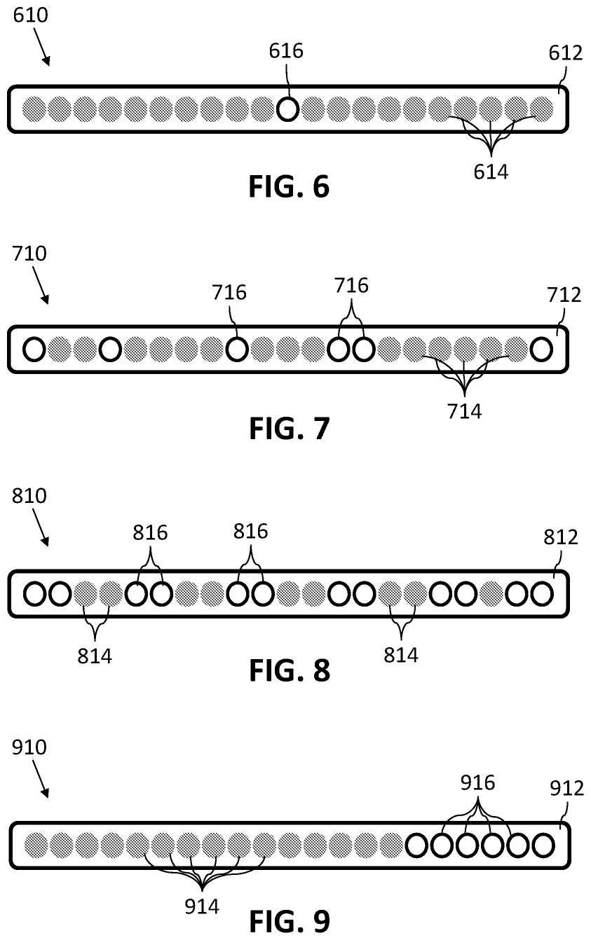

FIG. 6 illustrates a sectional view of a fiber belt 610 including a non-magnetic cord 614 and a ferrous cord 616. Belt 610 may include cords 614, 616 calendered in a material. The material may include a rubber material 612. It is understood that each of the elements of FIG. 6 may have the same properties as described above with respect to those elements of FIG. 2.

As illustrated, the ratio of ferrous cords 616 to total cords 614, 616 may be about 1:20. Ferrous cords 616 may be substantially evenly distributed amongst non-magnetic cords 614 across the width of belt 610.

FIG. 7 illustrates a sectional view of a fiber belt 710 including a non-magnetic cord 714 and a ferrous cord 716. Belt 710 may include cords 714, 716 calendered in a material. The material may include a rubber material 712. It is understood that each of the elements of FIG. 7 may have the same properties as described above with respect to those elements of FIG. 2.

As illustrated, the ratio of ferrous cords 716 to total cords 714, 716 may be about 1:3.5. Ferrous cords 716 may be unevenly distributed amongst non-magnetic cords 714 across the width of belt 710. That is, as illustrated, ferrous cords 716 may have a varying density in certain portions of the width of belt 710. Ferrous cords 716 may be randomly placed within belt 710. Additionally, a plurality of ferrous cords 716 may be oriented adjacent one another without any non-magnetic cord 714 oriented therebetween.

FIG. 8 illustrates a sectional view of a fiber belt 810 including a non-magnetic cord 814 and a ferrous cord 816. Belt 810 may include cords 814, 816 calendered in a material. The material may include a rubber material 812. It is understood that each of the elements of FIG. 8 may have the same properties as described above with respect to those elements of FIG. 2.

As illustrated, the ratio of ferrous cords 816 to total cords 814, 816 may be about 1:2. Ferrous cords 816 may be unevenly distributed amongst non-magnetic cords 814 across the width of belt 810. A plurality of ferrous cords 816 may be oriented adjacent one another without any non-magnetic cord 814 oriented therebetween.

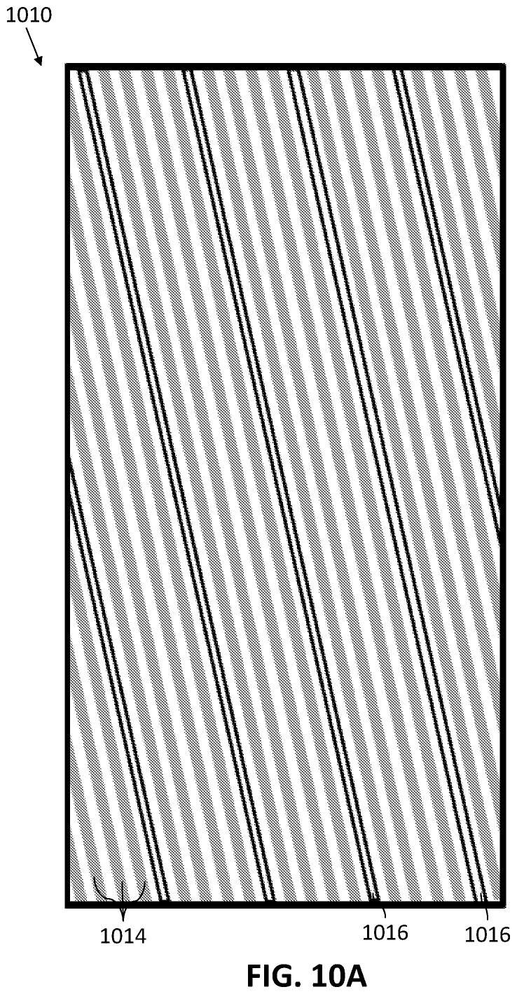

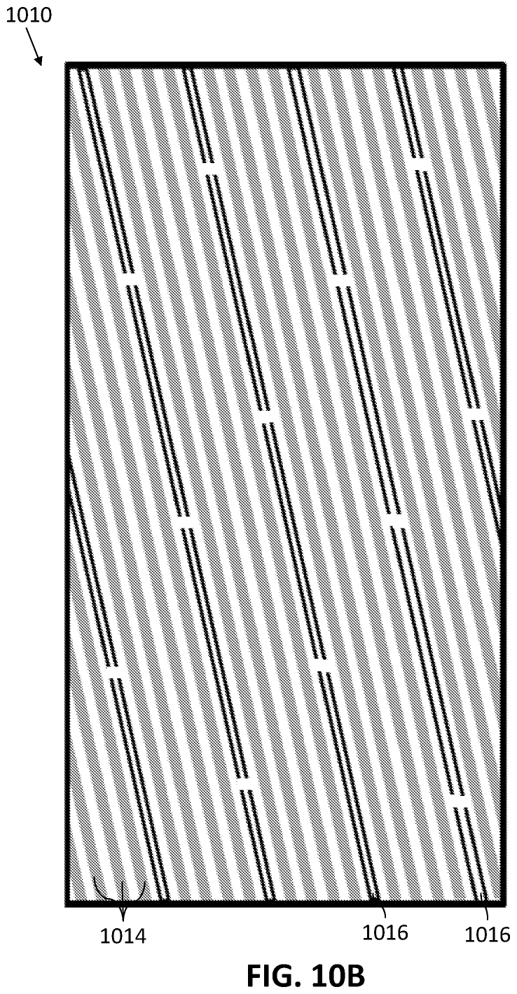

FIG. 9 illustrates a sectional view of a fiber belt 910 including a non-magnetic cord 914 and a ferrous cord 916. Belt 910 may include cords 914, 916 calendered in a material. The material may include a rubber material 912. It is understood that each of the elements of FIG. 9 may have the same properties as described above with respect to those elements of FIG. 2.

As illustrated, the ratio of ferrous cords 916 to total cords 914, 916 may be about 1:3.5. Ferrous cords 916 may be unevenly distributed amongst non-magnetic cords 914 across the width of belt 910. For example, a plurality of ferrous cords 916 may be oriented adjacent one another without any non-magnetic cord 914 oriented therebetween. In one embodiment, a plurality of ferrous cords 916 may be asymmetrically distributed in the width of belt 910. In one embodiment, a plurality of ferrous cords 916 may be oriented substantially near one edge of belt 910. In one embodiment, a plurality of ferrous cords 916 may be oriented substantially near both edges of belt 910, while no ferrous cords 916 are oriented near the center of belt 910.

FIG. 10A illustrates a top sectional view of a fiber belt 1010 including a non-magnetic cord 1014 and a ferrous cord 1016. Belt 1010 may include cords 1014, 1016 calendered in a material. The material may include a rubber material 1012. It is understood that each of the elements of FIG. 10A may have the same properties as described above with respect to those elements of FIG. 2.

As illustrated, cords 1014, 1016 may be inclined (angled) with respect to the circumferential direction of the tire. In one embodiment, cords 1014, 1016 are substantially parallel to the circumferential direction of the tire. As illustrated, cords 1014, 1016 may be discontinuous and may extend from at least one edge of belt 1010 to another, terminating at the edges of belt 1010.

FIG. 10B illustrates a sectional view of fiber belt 1010 including non-magnetic cord 1014 and ferrous cord 1016. In one embodiment, non-magnetic cord 1014 may be discontinuous and may extend from, and terminate in, at least one edge of belt 1010 to another. It is understood that each of the elements of FIG. 10B may have the same properties as described above with respect to those elements of FIG. 2.

Ferrous cord 1016 may be discontinuous and may not extend from, and terminate exclusively in, at least one edge of belt 1010 to another. That is, ferrous cord 1016 may terminate at one or more position between at least two edges of belt 1010. Ferrous cord 1016 may be discontinuous about its longitudinal length.

As illustrated in FIGS. 10A and 10B, non-magnetic cords 1014 may be substantially parallel to one another. Non-magnetic cords 1014 may be substantially parallel to ferrous cords 1016. Ferrous cords 1016 may be substantially parallel to one another.

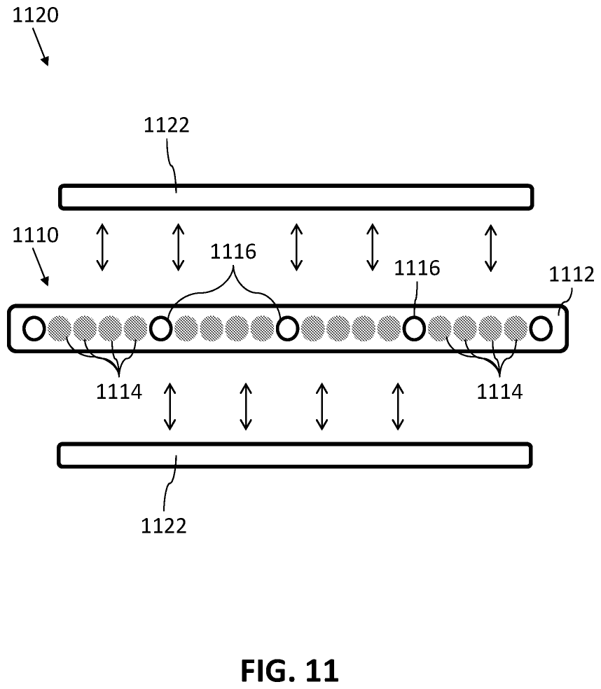

FIG. 11 illustrates a sectional view of a magnetic assist system 1120. System 1120 may include fiber belt 1110 including a non-magnetic cord 1114 and a ferrous cord 1116, interacting with magnetic handling devices 1122. Belt 1110 may include cords 1114, 1116 calendered in a material 1112. The material may include a rubber material 1112. It is understood that each of the elements of FIG. 11 may have the same properties as described above with respect to those elements of FIG. 2.

System 1120 may include at least one magnetic handling device 1122. At least one magnetic handling device 1122 may be oriented adjacent belt 1110. At least one magnetic handling device 1122 may be capable of producing a magnetic field that may attract at least one ferrous cord 1116 in belt 1110. At least one magnetic handling device 1122 may be an electromagnet. At least one magnetic handling device 1122 may be a magnetic material, including for example, a permanent magnet, a rare earth magnet, and the like.

At least one magnetic handling device 1122 may be part of magnetic assist system 1120 configured to manipulate fiber belt 1110 wherein fiber belt 1110 includes one or more ferrous cord 1116. Magnetic assist system 1120 may be configured to feed belt 1110 through a cutter. Magnetic assist system 1120 may be configured to feed belt 1110 through a drum server. Magnetic assist system 1120 may be configured to apply a cut section of belt 1110 to a tire carcass. Magnetic assist system 1120 may be configured to selectively capture and release the belt ply material through magnetic attraction between at least one magnetic handling device 1122 and ferrous cord 1116.

In one embodiment, magnetic assist system 1120 includes at least one magnetized feeder belt for manipulating belt 1110. At least one magnetic handling device 1122 may be at least one magnetized feeder belt.

In one embodiment, magnetic assist system 1120 includes at least one magnetic handling device 1122 oriented adjacent to belt 1110. In another embodiment, magnetic assist system 1120 includes more than one magnetic handling device 1122 oriented adjacent to belt 1110. In another embodiment, magnetic assist system 1120 includes at least two magnetic handling devices 1122 oriented on either side of belt 1110.

In practice, fiber belt 1110 may be oriented adjacent to at least one magnetic handling device 1122. Magnetic handling device 1122 may apply a magnetic field to belt 1110 and thus cause an attraction between at least one ferrous cord 1116 and magnetic handling device 1122. Magnetic handling device 1122 may be moved so as to cause desired movement of belt 1110.

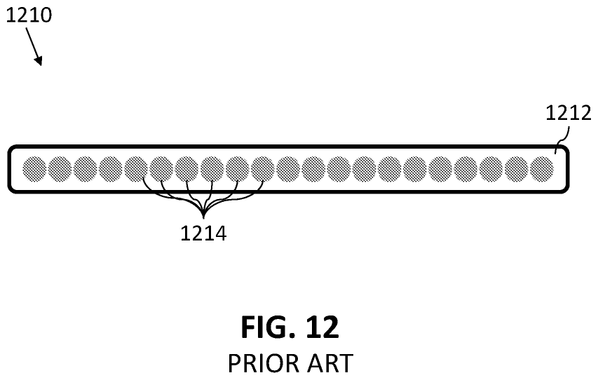

FIG. 12 illustrates a sectional view of a prior art belt 1210. Belt 1210 includes non-magnetic cords 1214. Belt 1210 may include non-magnetic cords 1214 calendered in a material 1212. The material may include a rubber material 1212. Belt 1210 does not include any ferrous cords. Belt 1210 does not include any ferrous materials, and as such, a magnetic field will not cause attraction between belt 1210 and a magnetic assist system or magnetic handling device.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A tire belt, comprising:
a plurality of non-magnetic cords oriented in a row parallel to one another;
at least one ferrous cord oriented in a row parallel to the plurality of non-magnetic cords; and
wherein the plurality of non-magnetic cords and the at least one ferrous cord are calendered in a rubber material.

2. The tire belt of claim 1, wherein the tire belt has a width measured in an axial direction of a tire, wherein the at least one ferrous cord is a plurality of ferrous cords, and wherein the plurality of ferrous cords are evenly distributed across the width of the tire belt.

3. The tire belt of claim 1, wherein each of the plurality of non-magnetic cords has a diameter, wherein the at least one ferrous cord has a diameter, and wherein the diameter of each of the plurality of non-magnetic cords is equal to the diameter of the at least one ferrous cord.

4. The tire belt of claim 1, wherein the plurality of non-magnetic cords and the at least one ferrous cord are oriented in the same row.

5. The tire belt of claim 1, wherein the at least one ferrous cord is oriented between two of the plurality of non-magnetic cords.

6. The tire belt of claim 1, wherein the at least one ferrous cord extends from a first edge of the tire belt to a second edge of the tire belt.

7. The tire belt of claim 1, wherein the at least one ferrous cord terminates between a first edge of the tire belt and a second edge of the tire belt.

8. Tire belt of claim 1, wherein the non-magnetic cords include a fiber material.

9. The tire belt of claim 1, wherein the non-magnetic cords include at least one of a fiberglass fiber and an aramid fiber.

10. A tire belt magnetic assist system, comprising:
a tire belt including:
a plurality of non-magnetic cords oriented in a row parallel to one another;
at least one ferrous cord oriented in a row parallel to the plurality of non-magnetic cords;
wherein the plurality of non-magnetic cords and the at least one ferrous cord are calendered in a rubber material; and
a magnetic assist system including at least one magnetic handling device.

11. The system of claim 10, wherein the at least one magnetic handling device is oriented adjacent to the tire belt and produces a magnetic field that attracts the at least one ferrous cord.

12. The system of claim 10, wherein the tire belt has a width measured in an axial direction of a tire, wherein the at least one ferrous cord is a plurality of ferrous cords, and wherein the plurality of ferrous cords are evenly distributed across the width of the tire belt.

13. The system of claim 10, wherein each of the plurality of non-magnetic cords has a diameter, wherein the at least one ferrous cord has a diameter, and wherein the diameter of each of the plurality of non-magnetic cords is equal to the diameter of the at least one ferrous cord.

14. The system of claim 10, wherein the plurality of non-magnetic cords and the at least one ferrous cord are oriented in the same row.

15. The system of claim 10, wherein the at least one ferrous cord is oriented between two of the plurality of non-magnetic cords.

16. The system of claim 10, wherein the at least one ferrous cord extends from a first edge of the tire belt to a second edge of the tire belt.

17. The system of claim 10, wherein the at least one ferrous cord terminates between a first edge of the tire belt and a second edge of the tire belt.

18. Tire system of claim 10, wherein the non-magnetic cords include a fiber material.

19. The system of claim 10, wherein the non-magnetic cords include at least one of a fiberglass fiber and an aramid fiber.

20. A tire, comprising:
a tire belt including:
a plurality of non-magnetic cords oriented in a row parallel to one another;
at least one ferrous cord oriented in a row parallel to the plurality of non-magnetic cords; and
wherein the plurality of non-magnetic cords and the at least one ferrous cord are calendered in a rubber material.
